(19) United States
(12) Patent Application Publication
(10) Pub. No.: US 2007/0129844 A1
(43) Pub. Date: Jun. 7, 2007

(54) AUTOMATIC MEDICINE PACKAGING MACHINE

(75) Inventor: Jun-ho KIM, Dalseo-Gu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: JVM CO., LTD, Dalseo-Gu (KR)

(21) Appl. No.: 11/673,960

(22) Filed: Feb. 12, 2007

Related U.S. Application Data
(63) Continuation-in-part of application No. 11/144,707, filed on Jun. 6, 2005.

(30) Foreign Application Priority Data
Jun. 10, 2004 (KR) 10-2004-0042735

(51) Int. Cl. G06F 17/00

(52) U.S. Cl. 700/231

(57) ABSTRACT

Disclosed is an automatic medicine packaging machine in which deterioration of sensing information due to accumulation of tablet dust is prevented, information on tablets and precise position of tablet cassette can be precisely detected even when operator mounts tablet cassette to tablet feeder, and tablet cassette is easily coupled with tablet feeder. The machine includes tablet cassettes having guide steps and accommodating tablets; tablet feeders having guide grooves into which the guide steps are inserted; a packaging device continuously packaging the tablets by doses; a memory including installing grooves, memory chips inserted into the installing grooves, and connection terminals; a reading device including a slot into which the connection terminals are inserted and a reader electrically connected to a control unit; and the control unit to control the tablet feeders and the packaging device to supply and package tablets corresponding to a prescription through information confirmed by the reading device.

### BACKGROUND OF THE INVENTION

1 . Field of the Invention

The present invention relates to an automatic medicine packaging machine, and more particularly to an automatic medicine packaging machine in which deterioration of information sensing rate due to accumulation of tablet dust is prevented, the information on the tablets accommodated in a tablet cassette and a precise position of the tablet cassette can be precisely detected even when an operator mounts the tablet cassette to a tablet feeder of his/her own free will, and the tablet cassette is easily coupled with the tablet feeder.

2 . Description of the Related Art

In general, an automatic medicine packaging machine is an apparatus to receive medicines of various kinds and to continuously package the received medicines by doses.

As an example of a conventional automatic medicine packaging machine, there is a tablet feeder, Japanese Unexamined Patent Application Publication No. 1994-256542(Oct. 21, 1994).

According to the conventional tablet feeder, when a controller marks an installation position of the tablet cassette on a tablet accommodating shelf in accordance with a prescription, an operator detaches the tablet cassette and mounts the detached tablet cassette to the marked tablet feeder of the conventional automatic medicine packaging machine.

The tablet feeder, in which the tablet cassette is installed in the conventional automatic medicine packaging machine, will be described as follows with reference to FIG. 6.

When the operator mounts a tablet cassette 200 to a tablet feeder 300 in the conventional automatic medicine packaging machine 100, a motor 301 of the tablet feeder 300 is driven to rotate a rotor 201 of the tablet cassette 200 such that the tablets accommodated in the tablet cassette 200 are discharged through a discharge hole 101 and are packaged by doses.

At that time, a controller determines whether the tablet cassette, which is installed by the operator, is installed at a proper position using an identification device 202 provided in the tablet cassette 200 and a determining device 302 provided in the tablet feeder 300.

However, the conventional automatic medicine packaging machine has the following drawbacks.

When tablet dust is generated during the rotation of the rotor and the tablet dust accumulates on the identification device and the determining device, detection ability by the devices deteriorates. Moreover, when the tablets are exhausted so that the tablet cassette is drawn out to supply the tablets while placing the tablet cassette on any shelf, tablet dust on the shelf attaches to the determining device installed to the lower side of the tablet cassette. Due to this, the detection ability of the determining device of the tablet feeder is deteriorates.

Since the operator must mount the tablet cassette to a predetermined position of the automatic medicine packaging machine, it is complicated and inconvenient to package the tablets over the entire process.

As described above, since the tablet cassette must be mounted to the predetermined position by an operator, incorrect mounting of the tablet cassette frequently happens.

### SUMMARY OF THE INVENTION

Therefore, the present invention has been made in view of the above problems, and it is an aspect of the present invention to provide an automatic medicine packaging machine in which deterioration of information sensing rate due to accumulation of tablet dust is prevented, information of the tablets accommodated in a tablet cassette and the precise position of the tablet cassette can be precisely detected even when an operator mounts the tablet cassette to a tablet feeder of his/her own free will, and the tablet cassette is easily coupled with the tablet feeder.

It is another aspect of the present invention to provide an automatic medicine packaging machine to prevent loss of tablet information caused by connection failure generated in the memory of a tablet cassette by vibration generated when discharging tablets and deterioration of sensing rate of the tablet information due to the loss of the information stored in memory.

It is still another aspect of the present invention to provide an automatic medicine packaging machine in which an operator can easily perceive information on tablets that are not accommodated in a tablet cassette so that the operator can promptly supply the omitted tablets into the tablet cassette.

In accordance with an aspect of the present invention, the above and other objects can be accomplished by the provision of an automatic medicine packaging machine comprising: a plurality of tablet cassettes horizontally installed to face a main body, having guide steps horizontally protruded, and to accommodate tablets; tablet feeders having guide grooves formed at upper lateral sides thereof such that the guide steps are inserted into the guide grooves and installed to an inner wall of the main body to supply the tablets; a packaging device to continuously package the tablets fed by the tablet feeders by doses; a memory including installing grooves formed in rear sides of the tablet cassettes, memory chips inserted into the installing grooves, and connection terminals formed in the memory chips and protruded over the installing grooves, and in which information on the tablets is stored; a reading device including a slot formed in an inner wall of the main body such that the connection terminals are inserted into the slot and a reader provided at a rear side of the slot and electrically connected to a control unit, and connected to the memory to read the information on the tablets; and the control unit to control the tablet feeders and the packaging device to supply and package tablets corresponding to a prescription through information on positions of the tablets confirmed by the reading device.

Moreover, the control unit supplies an electric power to the memory chips when the connection terminals are inserted into the slot such that the reader reads the information on the tablets stored in the memory chips, and interrupts the electric power of the memory chips after confirming the information on the tablets.

Moreover, the control unit compares preset information on tablets to be accommodated in the tablet cassettes with the information on the tablets accommodated in the tablet cassettes to extract information on the tablets to be accommodated in an empty tablet cassette.

Moreover, the automatic medicine packaging machine further comprises a display electrically connected to the control unit to display the information on the tablets to be accommodated in the empty tablet cassette extracted by the control unit to the exterior.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view illustrating an automatic medicine packaging machine according to the present invention;

FIG. 2 is an exploded perspective view illustrating a main part of an automatic medicine packaging machine according to the present invention;

FIG. 3 is a perspective view illustrating an assembly of the main part of the automatic medicine packaging machine in FIG. 2;

FIG. 4 is a vertical cross-sectional view schematically illustrating the assembly of FIG. 3;

FIG. 5 is a block diagram illustrating operation states of the automatic medicine packaging machine according to the present invention; and

FIG. 6 is a vertical cross-sectional view schematically illustrating a conventional automatic medicine packaging machine.

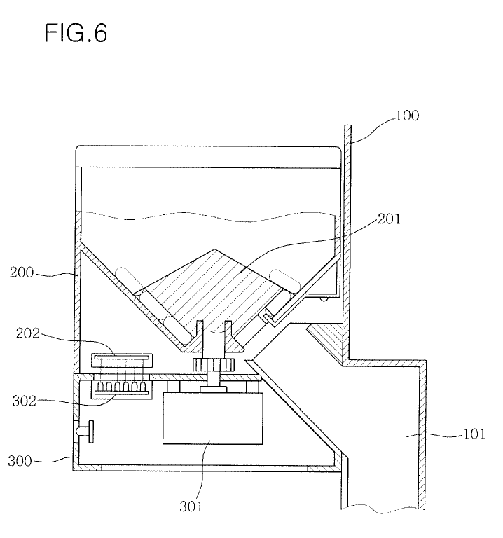

### DESCRIPTION OF THE PREFERRED EMBODIMENTS

With reference to the attached drawings, the preferred embodiment of the present invention is described in detail below.

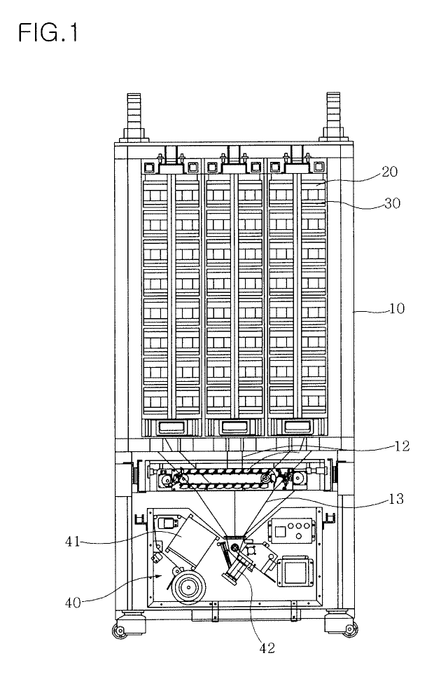

FIG. 1 is a front view illustrating an automatic medicine packaging machine according to the present invention.

As shown in FIG. 1, the automatic medicine packaging machine is configured such that a plurality of tablet feeders 30 is installed on walls of a main body 10, and a plurality of tablet cassettes 20 is slid to be coupled with the plurality of tablet feeders 30.

Tablets accommodated in the tablet cassettes 20 are discharged to a collection chute 12, which is installed in the main body 10, by the tablet feeder 30. The discharge tablets are collected in a hopper 13 and packaged by a package device 40 by doses.

The package device 40 includes a printer 41 to print dosage schedule on a tablet packaging sheet, and a sealing unit 42 to seal the tablet packaging sheet printed by the printer 41.

Namely, the tablet packaging sheets, on which the dosage schedule is printed by the printer 41, contain the tablets, by doses, which are dropped from the hopper 13, and are conveyed to the sealing unit 42 to be welded and packaged by the sealing unit 42.

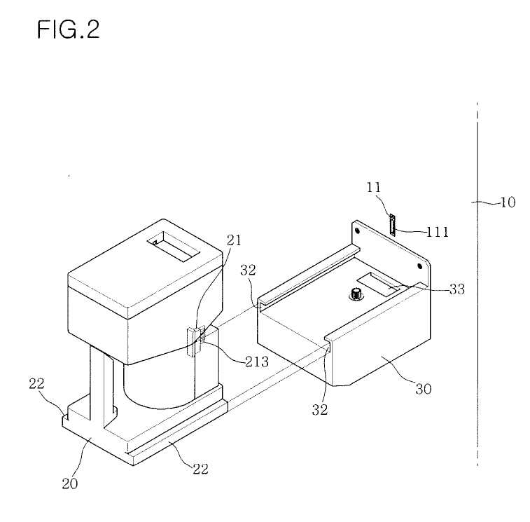

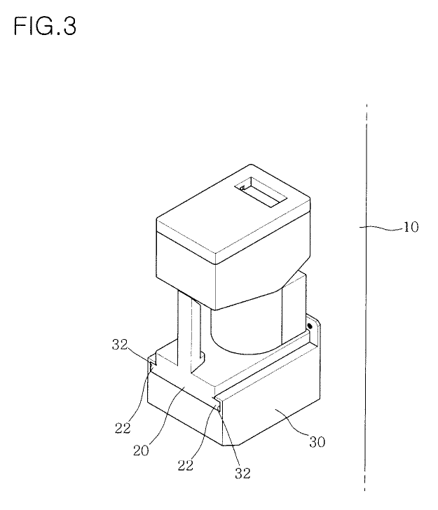

FIG. 2 is an exploded perspective view illustrating a main part of an automatic medicine packaging machine according to the present invention, and FIG. 3 is a perspective view illustrating an assembly of the main part of the automatic medicine packaging machine in FIG. 2.

As shown in FIGS. 2 and 3, the tablet cassette 20 is horizontally slid to be coupled with the tablet feeder 30 which is installed on the inner wall of the main body 10.

Namely, the tablet cassette 20 and the tablet feeder 30 are coupled with each other in such a way that guide steps 22 formed at lower lateral sides of the tablet cassette 20 are inserted into guide grooves 32 formed at upper lateral sides of the tablet feeder 30.

In this case, the tablet cassette 20 and the tablet feeder 30 are coupled with each other more securely by which connection terminals 213 of a memory chip 21 installed to a rear side of the tablet cassette 20 are inserted into a slot 111 of the reading device 11 installed to a rear side of the main body 10. As a result, tablet dust generated from the tablet feeder 30 can be easily prevented from being accumulated on the memory.

When information on the tablets stored in the memory 21 is read out by the reading device 11 and inputted to a control unit, the information on the tablets is confirmed by the control unit whenever the tablet cassette 20 is installed to any tablet feeder 30 by the operator so that the control unit can precisely recognize the position of the tablet cassette 20.

In accordance with the information on the position of the tablet cassette 20, the control unit drives the tablet feeder 30 such that the corresponding tablets accommodated in the tablet cassette 20 can be discharged in the main body 10 through the discharge chute 33.

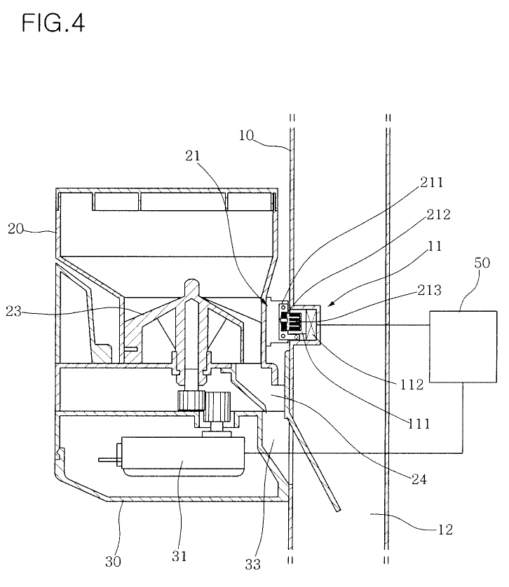

FIG. 4 is a vertical cross-sectional view schematically illustrating the assembly of FIG. 3.

As shown in FIG. 4, when the tablet cassette 20 is slid into and is coupled with the tablet feeder 30 installed in the main body 10, the memory 21 is connected to the reading device 11.

Also, gears of a motor 31 of the tablet feeder 30 are engaged with gears of a rotor 23 of the tablet cassette 20, so that the rotor 23 is rotated as the motor 31 is driven and the tablets accommodated in the tablet cassette 20 are discharged through a discharge hole 24, pass through the discharge chute 33, and are discharged to the collection chute 12.

The memory 21 includes an installing groove 211 formed in the rear side of the tablet cassette 20, a memory chip 212 inserted into the installing groove 211, and the connection terminals 213 formed in the memory chip 212 to be protruded over the installing groove 211.

The memory 21 is connected to the reading device 11 in a state where information on the tablets accommodated in the tablet cassette 20 is stored in the memory chip 212, and serves to provide the information on the tablet to the reading device 11.

Also, the reading device 11 includes a slot 111, into which the connection terminals 213 of the memory 21 is inserted, installed on the wall of the main body 10, and a reader 112 electrically connected to the control unit 50 and provided at the rear side of the slot 111.

The reading device 11 reads the information on the tablets stored in the memory chip 212 by the reader 112 in a state where the connection terminals 213 of the memory chip 212 are inserted in the slot 111, and inputs the read information on the tablets to the control unit 50.

The control unit 50, received the information on the tablets from the reading device 11, confirms a position of a tablet cassette 20 corresponding to the read information on the tablets, and controls the motor 31 to discharge the corresponding tablets.

The control unit 50 applies an electric power to the memory chip 212 when the connection terminals 213 are inserted into the slot 111 such that the reader 112 reads the information on the tablets stored in the memory chip 212, and confirms and recognizes the information on the tablets stored in the memory chip 212 using the reader 112 to interrupt the power supplied to the memory chip 212.

As such, the control unit 50 recognizes the information on the tablets stored in the memory chip 212 and immediately interrupts the power supplied to the memory chip 212 to prevent the loss of information stored in the memory chip 212 due to the connection failure generated in the memory chip 212 by vibration of the tablet cassette 20 caused by the driving of the motor 31 of the tablet feeder 30.

Accordingly, the automatic medicine packaging machine according to the present invention is configured such that, when an operator makes any tablet cassette 20 slide into to the tablet feeder 30 such that the tablet cassette 20 is coupled with the tablet feeder 30, the memory 21 and the reading device 11 are mutually connected to each other and information on the tablets accommodated in the tablet cassette 20 is inputted to the control unit 50, so that the control unit 50 can confirm the position of the tablet cassette 20 and the information stored in the memory can be prevented from being lost due to the vibration of the tablet cassette.

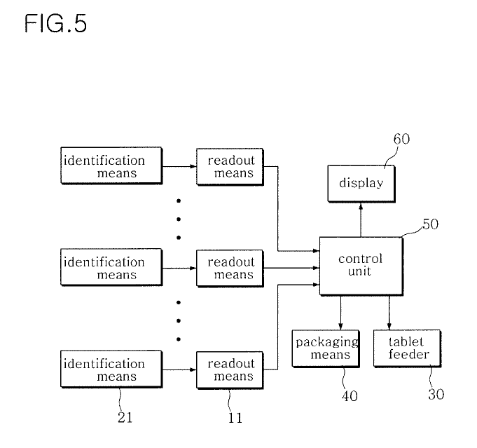

FIG. 5 is a block diagram illustrating operation states of the automatic medicine packaging machine according to the present invention.

As shown in FIG. 5, when a plurality of tablet cassettes, each of which has a memory 21, is coupled with and installed in the tablet feeders 30, the memories 21 are connected to the reading devices 11 such that the control unit 50 can confirm the information of the tablets accommodated in the tablet cassettes through the reading devices 11.

At that time, the control unit 50 compares information on kinds of the tablets preset to be accommodated in the tablet cassettes 20 with the information of the respective tablets inputted from the reading devices 11 to extract information on a tablet omitted now, tablet to be accommodated in an empty tablet cassette in the future, and to display the extracted information on the tablet on a display 60, so that the operator can read the information of the omitted tablet and can promptly supply the omitted tablet to the empty tablet cassette.

The display 60, electrically connected to the control unit 50, displays the information on the tablet to be accommodated in the empty tablet cassette such that the operator can see the information and may be a conventional display.

In addition, when the entire tablet cassette 20 is installed in the tablet feeders 30, the control unit 50 confirms the position of the entire tablet cassette 20 and drives the tablet feeders 30 in which corresponding tablet cassettes 20 are installed in accordance with inputted prescription such that the tablets are discharged.

The control unit 50 drives the tablet feeders 30 according to the inputted prescription to discharge the tablets by doses. After that, the control unit 50 controls the packaging device 40 to seal and package the discharged tablets.

As mentioned above, the present invention provides an automatic medicine packaging machine in which deterioration of information sensing rate due to accumulation of tablet dust is prevented, information on tablets accommodated in a tablet cassette and the precise position of the tablet cassette can be precisely detected even when an operator mounts the tablet cassette to a tablet feeder of his/her own free will manually, and the tablet cassette is easily coupled with the tablet feeder.

Moreover, the present invention provides an automatic medicine packaging machine to prevent loss of tablet information stored in a memory caused by a connection failure by vibration that is generated when discharging tablets and deterioration of sensing tablet information due to the loss of the information stored in the memory.

Further, the present invention provides an automatic medicine packaging machine in which an operator can easily read the information on tablets that are not accommodated in a tablet cassette so that the operator can promptly supply the omitted tablets into the tablet cassette.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An automatic medicine packaging machine comprising:
a plurality of tablet cassettes horizontally installed to face a main body, having guide steps horizontally protruded, and to accommodate tablets;
tablet feeders having guide grooves formed at upper lateral sides thereof such that the guide steps are inserted into the guide grooves and installed to an inner wall of the main body to supply the tablets;
a packaging device to continuously package the tablets fed by the tablet feeders by doses;
a memory including installing grooves formed in rear sides of the tablet cassettes, memory chips inserted into the installing grooves, and connection terminals formed in the memory chips and protruded over the installing grooves, and in which information on the tablets is stored;
a reading device including a slot formed in an inner wall of the main body such that the connection terminals are inserted into the slot and a reader provided at a rear side of the slot and electrically connected to a control unit, and connected to the memory to read the information on the tablets; and
the control unit to control the tablet feeders and the packaging device to supply and package tablets corresponding to a prescription through information on positions of the tablets confirmed by the reading device.

2. The automatic medicine packaging machine according to claim 1, wherein the control unit supplies an electric power to the memory chips when the connection terminals are inserted into the slot such that the reader reads the information on the tablets stored in the memory chips, and interrupts the electric power of the memory chips after confirming the information on the tablets.

3. The automatic medicine packaging machine according to claim 2, wherein the control unit compares preset information on tablets to be accommodated in the tablet cassettes with the information on the tablets accommodated in the tablet cassettes to extract information on the tablets to be accommodated in an empty tablet cassette.

4. The automatic medicine packaging machine according to claim 3, further comprising a display electrically connected to the control unit to display the information on the tablets to be accommodated in the empty tablet cassette extracted by the control unit to the exterior.
